(19) United States
(12) Patent Application Publication
(10) Pub. No.: US 2021/0031648 A1
(43) Pub. Date: Feb. 4, 2021

(54) CHARGING MANAGEMENT SERVER AND METHOD FOR CHARGING MANAGEMENT

(71) Applicant: Noodoe Corporation, Taipei City (TW)

(72) Inventor: John C. Wang, Taipei City (TW)

(21) Appl. No.: 16/943,043

(22) Filed: Jul. 30, 2020

(30) Foreign Application Priority Data
Aug. 1, 2019 (TW) 108127305

(51) Int. Cl. B60L 53/68; B60L 53/30; B60L 53/66

(52) U.S. Cl. CPC B60L 53/68; B60L 53/66; B60L 53/305

(57) ABSTRACT

A charging management server includes: a network connection unit that receives a charging reservation request from a user terminal, wherein the charging reservation request includes the identification information of a reservation target; a storage unit storing charging device identification information corresponding to a charging device and a reservation status schedule; and a processor specifying the charging device identification information and the corresponding reservation status schedule consistent with the identification information of the reservation target according to the identification information of the reservation target, wherein the processor obtains the current time when receiving the charging reservation request, determines a start charging time corresponding to the charging reservation request according to the current time and the reservation status schedule, and returns the start charging time to the user terminal, so as to obtain payment confirmation information that agrees to start charging at the start charging time from the user terminal.

### BACKGROUND OF THE INVENTION

### Field of the Invention

The disclosure relates generally to charging management servers and methods thereof, and, more particularly to charging management servers and methods that can perform related managements for charging devices of electric vehicles.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

On the other hand, compared with the time required for refueling of traditional vehicles, the time required for charging electric vehicles is significantly longer. Therefore, when charging devices, such as charging stations, are already occupied, users may spend a lot of waiting time due to that the charging station is being occupied or need to waste time to find other charging stations for charging, resulting in inconvenience in use and reducing the willingness to use.

### BRIEF SUMMARY OF THE INVENTION

Charging management servers and methods for charging management of charging devices are provided, which can manage the charging period reservations of the charging device of electric vehicles, allowing users of electric vehicles to reserve charging periods remotely without spending a lot of time in waiting in line at the charging station, thereby further increasing the revenue of charging device and reducing the idle time of charging device.

An embodiment of a charging management server, comprises: a network connection unit configured to enable the charging management server to remotely connect to a charging device and a user terminal through a network, wherein the network connection unit receives a charging reservation request from a user terminal through the network, and wherein the charging reservation request comprises identification information of a reservation target which records identification information of a charging device serving as the reservation target; a storage unit configured to store charging device identification information corresponding to the charging device and a reservation status schedule; and a processor configured to obtain current time when receiving the charging reservation request, specify the charging device identification information and the corresponding reservation status schedule consistent with the identification information of the reservation target according to the identification information of the reservation target from the storage unit, determine a start charging time corresponding to the charging reservation request according to the current time and the reservation status schedule, and return the start charging time to the user terminal, so as to obtain payment confirmation information that agrees to start charging at the start charging time from the user terminal.

In an embodiment of a method for charging management of charging devices for use in a charging management server, wherein the charging management server is remotely connected to a charging device and a user terminal, the method comprises: storing charging device identification information corresponding to the charging device and a reservation status schedule; receiving a charging reservation request from the user terminal via the network, wherein the charging reservation request comprises identification information of a reservation target, which records identification information of a charging device serving as the reservation target; in response to receiving the charging reservation request, obtaining current time, and specifying the charging device identification information and the reservation status schedule corresponding thereto consistent with the identification information of the reservation target according to the identification information of the reservation target from the stored charging device identification information; determining a start charging time corresponding to the charging reservation request according to the current time and the reservation status schedule; and returning the start charging time to the user terminal, so as to obtain payment confirmation information that agrees to start charging at the start charging time from the user terminal.

In some embodiments, the charging reservation request further comprises electric vehicle identification information and user identification information, and the processor further transmits a charging authorization instruction to the charging device via the network connection unit for allowing the charging device to charge the electric vehicle whose electric vehicle identification information and user identification information corresponding to the electric vehicle identification information and the user identification information among the electric vehicles connected to the charging device after the start charging time arrives.

In some embodiments, the processor further updates the reservation status schedule by setting a reservation permission status to a non-reservable state starting from the start charging time according to the start charging time, and then updates the reservation status schedule again by setting the reservation permission status to a reservation available state from the time when the charging service is completed when receiving a notification that the charging device has completed the charging service corresponding to the charging reservation request.

In some embodiments, when receiving the notification that the charging device has completed the charging service corresponding to the charging reservation request, the processor further calculates a charging fee during the time period from the start charging time to the time when the charging service is completed, and performs a payment process based on the payment confirmation information and the charging fee.

In some embodiments, wherein the processor further compares the reservation status schedule with the current time, and sets the current time to be the start charging time when determining that the charging device is in a reservation available state at the current time.

In some embodiments, the processor further compares the reservation status schedule with the current time, and sets a time point after adding a buffer time to the current time to be the start charging time when determining that the charging device is in a reservation available state at the current time.

In some embodiments, the processor further compares the reservation status schedule with the current time, and sets the time when the charging device is converted to a reservation available state to be the start charging time when determining that the charging device is in a non-reservable state at the current time.

In some embodiments, the processor further compares the reservation status schedule with the current time, and sets a time point after adding a buffer time to the time when the charging device is converted to a reservation available state to be the start charging time when determining that the charging device is in a non-reservable state at the current time.

Methods for charging management of charging devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an environment suitable for a charging management server of the invention;

FIG. 2 is a schematic diagram illustrating an embodiment of a charging management server of the invention:

FIG. 3 and FIG. 4 show a flowchart of an embodiment of a method for charging management of charging devices of the invention; and

FIG. 5 is a flowchart of another embodiment of a method for charging management of charging devices of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide charging management servers and related methods for charging management of charging devices, which can manage the charging time period reservations of the charging device of electric vehicles, allowing users of electric vehicles to reserve charging periods remotely without spending a lot of time in waiting in line at the charging station. With the charging management servers and related methods for charging management of charging devices of the invention, the waiting time spent by the user due to the occupation of the charging station or the time and spirit of looking for other charging stations can be effectively reduced, thus improving the user's experience and increasing the user's willingness to use related electric vehicle charging services, and further increasing the revenue of charging device and reducing the idle time of charging device.

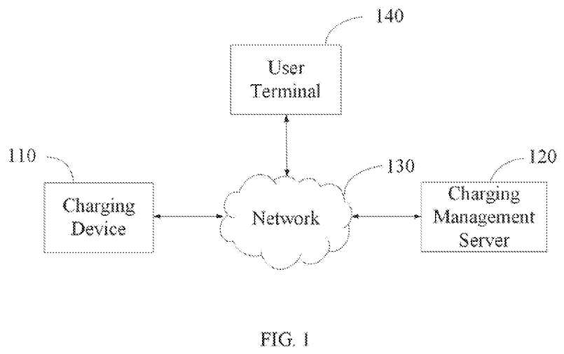

FIG. 1 is a schematic diagram illustrating an embodiment of an environment suitable for a charging management server of the invention. As shown in FIG. 1, a charging management server 120 of the present invention is remotely connected to a charging device 110 and a user terminal 140 via a network 130. In some embodiments, the network 130 may be a wired network, a telecommunication network, and a wireless network, such as a Wi-Fi network or the like. The server 120 may receive a charging reservation request from the user terminal 140, and after completing the charging reservation and payment confirmation according to the charging reservation request, it generates a charging authorization instruction and transmits it to the charging device 110 via the network 130, so as to allow the charging device 110 to output power starting at a certain time to an electric vehicle (for example, an electric scooters or an electric car) which is electronically connected to the charging device 110 or prohibit the charging device 110 from outputting power to the electric vehicle. For example, the charging device 110 may be an electric vehicle charger, which is provided with a single charging connector or multiple charging connectors, and output electric power to charge the electronic vehicle through the charging connector(s).

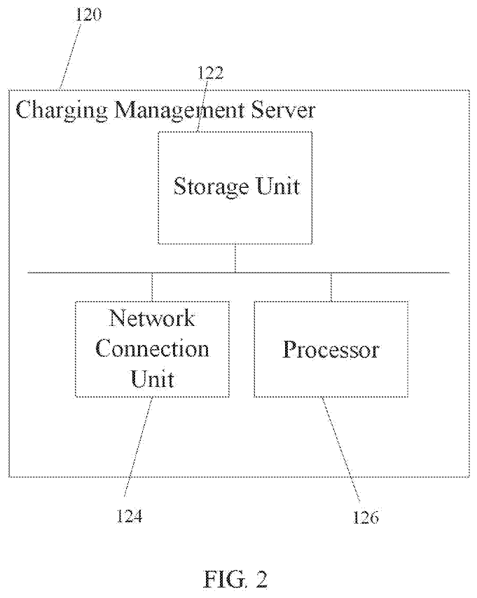

FIG. 2 is a schematic diagram illustrating an embodiment of a charging management server of the invention. As shown in FIG. 2, the charging management server 120 of the invention can be any processor-based electronic device which comprises at least a storage unit 122, a network connection unit 124, and a processor 126. It is noted that, the charging management server 120 can perform charging management operations of the charging device 110. The charging management operations may include reservation scheduling management of the charging device 110 and related payment operations.

The network connection unit 124 is configured to enable the charging management server 120 to remotely connect to the charging device 110 and the user terminal 140 via the network 130, and it can transmit relevant data to a plurality of charging devices 110 and a plurality of user terminals 140 via the network 130, receive charging requests or charging reservation requests from one or more user terminals 140 via the network 130, and control the charging device 110 whether to output electric power to charge an electric vehicle.

According to an embodiment, the network connection unit 124 receives a charging reservation request from the user terminal 140 via the network 130, wherein the charging reservation request includes identification information of a reservation target, which records the identification information of a charging device served as the reservation target. Through the network connection unit 124, the charging management server 120 can be coupled to and communicate with the charging device 110 and the user terminal 140 via the network 130. The storage unit 122 (e.g., a memory) can store and record related data, such as user identification information corresponding to users who have registered for the charging service and respective electric vehicle identification information, and store charging device identification information corresponding to the charging device and reservation status schedule and so on. It is noted that, above data is merely examples of the application, and the present invention is not limited thereto. The processor 126 can control related operations of software and hardware in the charging management server 120 to perform the method for charging management of charging devices of the invention, the details of which will be described later. For example, the processor 126 can be a general-purpose controller, a micro-control unit (MCU), a digital signal processor (DSP), or the like, which provides the function of data analyzing, processing, and computing. However, it is understood that the present invention is not limited thereto.

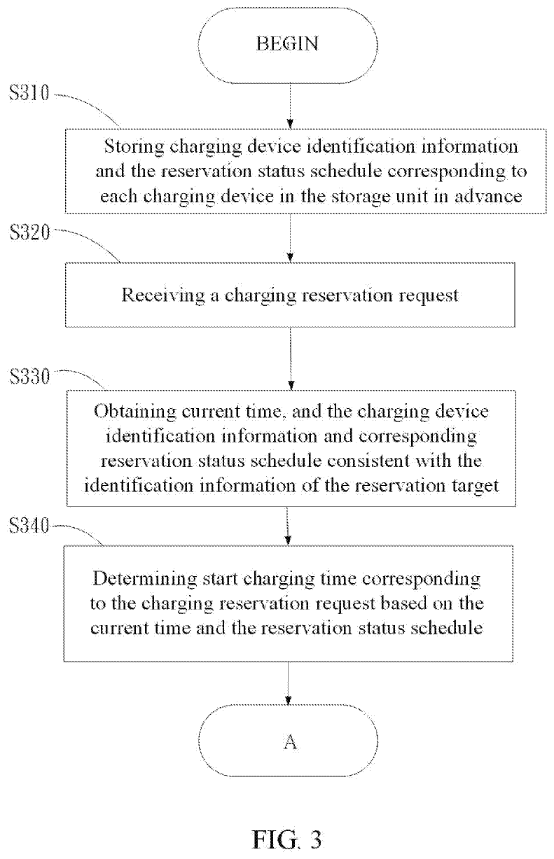

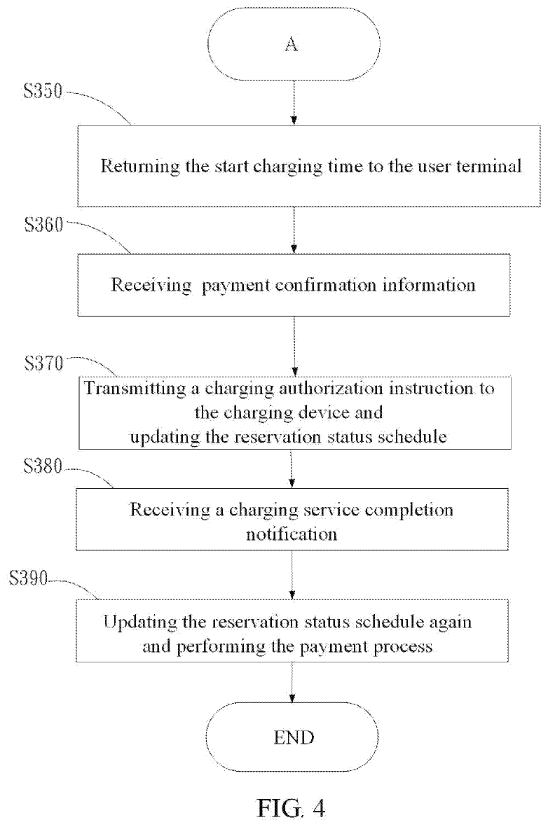

Please refer together with FIG. 3 and FIG. 4. FIG. 3 and FIG. 4 show a flowchart of an embodiment of a method for charging management of charging devices of the invention. The method for charging management of charging devices of the invention can be applied to the environment as shown in FIG. 1 and performed by the processor 126 of the charging management server 120.

First, in step S310, the charging device identification information and the reservation status schedule corresponding to each charging device are stored in the storage unit 122 in advance.

In step S320, a charging reservation request from the user terminal 140 is received by the network connection unit 124 of the charging management server 120 via the network 130, wherein the charging reservation request is used to make a reservation for the charging device 110 to reserve the charging device 110 for charging an electric vehicle after specific time points to ensure that the charging device 110 will not be occupied by other electric vehicles when the user's electric vehicle reaches the charging device 110. In one embodiment, the above-mentioned charging reservation request message may include the identification information of the reservation target, which records the identification information of the charging device as the reservation target, such as the identification information of a specific charging station or the identification information of one of the charging cables for a specific charging station. In another embodiment, the electric vehicle identification information and user identification information can also be recorded in the charging reservation request message.

In step S330, when the processor 126 receives the charging reservation request, it obtains a current time, and specify the charging device identification information and the corresponding reservation status schedule consistent with the identification information of the reservation target from the storage unit 122 according to the identification information of the reservation target. With this step, it is possible to lock the charging device that the user wants to reserve and its existing reservation status schedule. The above reservation status schedule may record when the reservation permission status of the corresponding charging device is available for reservation (also referred to as a “reservation available state”) and when is not available for reservation (also referred to as a “non-reservable state”).

In step S340, a start charging time corresponding to the charging reservation request is determined based on the current time and the reservation status schedule.

Then, in step S350, the start charging time is returned to the user terminal, and in step S360, payment confirmation information that agrees to start charging at the start charging time is obtained from the user terminal.

In step S370, a charging authorization instruction is transmitted to the charging device 110 and the reservation status schedule is updated according to the start charging time. The charging authorization instruction can be used to enable the charging device 110 to allow the charging device to charge the electric vehicle whose electric vehicle identification information and user identification information corresponding to the electric vehicle identification information and the user identification information recorded in the charging reservation request among the electric vehicles connected to the charging device after the start charging time arrives. The update of the above-mentioned reservation status schedule is to set the reservation permission status of the charging device 110 to the non-reservable state from the above-mentioned start charging time.

In step S380, a charging service completion notification is received, which indicates that the charging device 110 has completed the charging service corresponding to the charging reservation request. For example, when the user has separated the charging cable from the electric vehicle, or inserted the charging cable into the charging station, it means that the charging device 110 has completed the charging service corresponding to the charging reservation request.

In step S390, the reservation status schedule is updated again and the payment/checkout process is performed. The renewal of the above-mentioned reservation status schedule is to set the reservation permission status of the charging device 110 to a reservation available state from the time when the charging service has been completed. The above payment process may be performed by calculating a charging fee during the time period from the start charging time to the time when the charging service is completed, and performing the payment process based on the payment confirmation information and the charging fee.

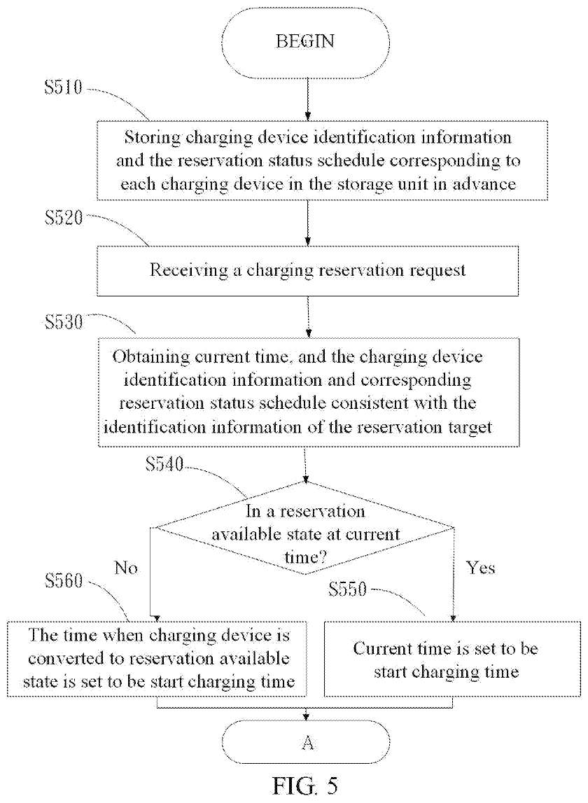

FIG. 5 is a flowchart of another embodiment of a method for charging management of charging devices for the charging management server to determine the start charging time of the invention. The method can be applied to the environment as shown in FIG. 1 and performed by the processor 126 of the charging management server 120.

First, in step S510, the charging device identification information and the reservation status schedule corresponding to each charging device are stored in the storage unit 122 in advance.

In step S520, a charging reservation request from the user terminal 140 is received by the network connection unit 124 of the charging management server 120 via the network 130, wherein the charging reservation request is used to make a reservation for the charging device 110 to reserve the charging device 110 for charging an electric vehicle after specific time points to ensure that the charging device 110 will not be occupied by other electric vehicles when the user's electric vehicle reaches the charging device 110. In one embodiment, the above-mentioned charging reservation request message may include the identification information of the reservation target, which records the identification information of the charging device as the reservation target, such as the identification information of a specific charging station or the identification information of one of the charging cables for a specific charging station. In another embodiment, the electric vehicle identification information and user identification information can also be recorded in the charging reservation request message.

In step S530, when the processor 126 receives the charging reservation request, it obtains a current time, and specify the charging device identification information and the corresponding reservation status schedule consistent with the identification information of the reservation target from the storage unit 122 according to the identification information of the reservation target. With this step, it is possible to lock the charging device that the user wants to reserve and its existing reservation status schedule. The above reservation status schedule may record when the reservation permission status of the corresponding charging device is available for reservation (also referred to as a “reservation available state”) and when is not available for reservation (also referred to as a “non-reservable state”).

In step S540, the reservation status schedule is compared with the current time, and it is determined whether the reservation permission status of the charging device 110 at the current time is in a reservation available state.

In step S550, when it is determined that the charging device 110 is in the reservation available state at the current time, the current time is set to be the start charging time. That is, even if the user has not driven the electric vehicle to the charging device 110, he can first occupy the charging device 110 by submitting a charging reservation request. When the user drives the car to the charging device 110, the charging can be performed immediately without needing to wait due to that the charging device 110 is occupied by others. In another embodiment, when it is determined that the charging device 110 is in the reservation available state at the current time, a time point after adding a buffer time to the current time is set to be the start charging time. That is, even if the user has not driven the electric vehicle to the charging device 110, he can first occupy the charging device 110 by submitting a charging reservation request. When the user drives the car to the charging device 110, the charging can be performed immediately without needing to wait due to that the charging device 110 is occupied by others. However, because the user may actually a distance away from the charging device 110, it is not necessary to start charging immediately, and give the user a buffer time before charging starts.

In step S560, the processor compares the reservation status schedule with the current time, and when it is determined that the charging device is in a non-reservable state at the current time, the time when the charging device is converted to a reservation available state is set to be the start charging time. That is, if the current reservation permission status of the charging device 110 is in the non-reservable state (e.g., the charging device 110 is performing a charging service, or it is scheduled to be charged by another user, etc.), the user can choose to wait and occupy the charging device 110 by submitting a charging reservation request, then go for other activities. When the reservation permission status of the charging device 110 is changed to the reservation available state, the user can obtain the first charging order for charging while no needing to wait for the charging device 110 to be available due to that it is being occupied by other people. In another embodiment, when it is determined that the charging device 110 is in a non-reservable state at the current time, the start charging time may also be a moment or time point when the charging device 110 is converted to a reservation available state and passes a buffer time. That is, when the charging device 110 is in the non-reservable state at the current time, the user can reserve the charging device 110 by making a charging reservation request first and choose to go to the location of the charging device 110 to charge later when the charging permission state of the charging device 110 is converted to the reservation available state. However, because the user may be a distance away from the charging device 110 when the charging permission state of the charging device 110 is converted to the reservation available state, it is not necessary to start charging immediately, and give the user a buffer time before charging starts.

Therefore, the charging management servers and systems and methods for charging management of charging devices thereof of the present invention can manage the charging time period reservations of the charging device of electric vehicles, allowing users of electric vehicles to reserve charging periods remotely without spending a lot of time in waiting in line at the charging station, thereby further increasing the revenue of charging device and reducing the idle time of charging device.

Methods for charging management of charging devices, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging management server, comprising:
a network connection unit configured to enable the charging management server to remotely connect to a charging device and a user terminal through a network, wherein the network connection unit receives a charging reservation request from a user terminal through the network, and wherein the charging reservation request comprises identification information of a reservation target which records identification information of a charging device serving as the reservation target;
a storage unit configured to store charging device identification information corresponding to the charging device and a reservation status schedule; and
a processor configured to obtain current time when receiving the charging reservation request, specify the charging device identification information and the corresponding reservation status schedule consistent with the identification information of the reservation target according to the identification information of the reservation target from the storage unit, determine a start charging time corresponding to the charging reservation request according to the current time and the reservation status schedule, and return the start charging time to the user terminal, so as to obtain payment confirmation information that agrees to start charging at the start charging time from the user terminal.

2. The charging management server of claim 1, wherein the charging reservation request further comprises electric vehicle identification information and user identification information, and the processor further transmits a charging authorization instruction to the charging device via the network connection unit for allowing the charging device to charge the electric vehicle whose electric vehicle identification information and user identification information corresponding to the electric vehicle identification information and the user identification information among the electric vehicles connected to the charging device after the start charging time arrives.

3. The charging management server of claim 1, wherein the processor further updates the reservation status schedule by setting a reservation permission status to a non-reservable state starting from the start charging time according to the start charging time, and then updates the reservation status schedule again by setting the reservation permission status to a reservation available state from the time when the charging service is completed when receiving a notification that the charging device has completed the charging service corresponding to the charging reservation request.

4. The charging management server of claim 1, wherein when receiving the notification that the charging device has completed the charging service corresponding to the charging reservation request, the processor further calculates a charging fee during the time period from the start charging time to the time when the charging service is completed, and performs a payment process based on the payment confirmation information and the charging fee.

5. The charging management server of claim 1, wherein the processor further compares the reservation status schedule with the current time, and sets the current time to be the start charging time when determining that the charging device is in a reservation available state at the current time.

6. The charging management server of claim 1, wherein the processor further compares the reservation status schedule with the current time, and sets a time point after adding a buffer time to the current time to be the start charging time when determining that the charging device is in a reservation available state at the current time.

7. The charging management server of claim 1, wherein the processor further compares the reservation status schedule with the current time, and sets the time when the charging device is converted to a reservation available state to be the start charging time when determining that the charging device is in a non-reservable state at the current time.

8. The charging management server of claim 1, wherein the processor further compares the reservation status schedule with the current time, and sets a time point after adding a buffer time to the time when the charging device is converted to a reservation available state to be the start charging time when determining that the charging device is in a non-reservable state at the current time.

9. A method for charging management of charging devices for use in a charging management server, wherein the charging management server is remotely connected to a charging device and a user terminal, the method comprising:
storing charging device identification information corresponding to the charging device and a reservation status schedule;
receiving a charging reservation request from the user terminal via the network, wherein the charging reservation request comprises identification information of a reservation target, which records identification information of a charging device serving as the reservation target;
in response to receiving the charging reservation request, obtaining current time, and specifying the charging device identification information and the reservation status schedule corresponding thereto consistent with the identification information of the reservation target according to the identification information of the reservation target from the stored charging device identification information;
determining a start charging time corresponding to the charging reservation request according to the current time and the reservation status schedule; and
returning the start charging time to the user terminal, so as to obtain payment confirmation information that agrees to start charging at the start charging time from the user terminal.

10. The method of claim 9, wherein the charging reservation request further comprises electric vehicle identification information and user identification information, and the method further transmitting a charging authorization instruction to the charging device for allowing the charging device to charge the electric vehicle whose electric vehicle identification information and user identification information corresponding to the electric vehicle identification information and the user identification information among the electric vehicles connected to the charging device after the start charging time arrives.

11. The method of claim 9, further comprising:
updating the reservation status schedule by setting a reservation permission status to a non-reservable state starting from the start charging time according to the start charging time, and then updating the reservation status schedule again by setting the reservation permission status to a reservation available state from the time when the charging service is completed when receiving a notification that the charging device has completed the charging service corresponding to the charging reservation request.

12. The method of claim 9, further comprising:
when receiving the notification that the charging device has completed the charging service corresponding to the charging reservation request, calculating a charging fee during the time period from the start charging time to the time when the charging service is completed, and performing a payment process based on the payment confirmation information and the charging fee.

13. The method of claim 9, further comprising:
comparing the reservation status schedule with the current time, and setting the current time to be the start charging time when determining that the charging device is in a reservation available state at the current time.

14. The method of claim 9, further comprising:
comparing the reservation status schedule with the current time, and setting a time point after adding a buffer time to the current time to be the start charging time when determining that the charging device is in a reservation available state at the current time.

15. The method of claim 9, further comprising:
comparing the reservation status schedule with the current time, and setting the time when the charging device is converted to a reservation available state to be the start charging time when determining that the charging device is in a non-reservable state at the current time.

16. The method of claim 9, further comprising:
comparing the reservation status schedule with the current time, and setting a time point after adding a buffer time to the time when the charging device is converted to a reservation available state to be the start charging time when determining that the charging device is in a non-reservable state at the current time.
